(19) United States
(12) Patent Application Publication
(10) Pub. No.: US 2010/0020742 A1
(43) Pub. Date: Jan. 28, 2010

(54) HYBRID SPACECRAFT FOR COMMUNICATIONS AND REMOTE SENSING

(75) Inventors: Neil E. Goodzeit, Princeton, NJ (US); Harald J. Weigl, Doylestown, PA (US); John C. Petheram, Washington, DC (US); Andy A. Santoro, Doylestown, PA (US)

Correspondence Address: MCDERMOTT WILL & EMERY LLP, 18191 VON KARMAN AVE., SUITE 500, IRVINE, CA, 92612-7108, US

(73) Assignee: Lockheed Martin Corporation, Bethesda, MD (US)

(21) Appl. No.: 12/506,192

(22) Filed: Jul. 20, 2009

Related U.S. Application Data
(60) Provisional application No. 61/083,500, filed on Jul. 24, 2008.

(51) Int. Cl. H04B 7/185; B64G 1/66; B64G 1/10

(52) U.S. Cl. 370/316; 244/173.2; 455/12.1

(57) ABSTRACT

Various aspects of the disclosure provide hybrid spacecraft capable of hosting both a remote sensing payload and a communications payload. A hybrid spacecraft includes an isolation system for a remote sensing payload that isolates the remote sensing payload from spacecraft dynamics and disturbances, and prevents interaction between the remote sensing and communications payloads. The hybrid spacecraft may also include provisions for a communications payload including metering structure for large aperture antennas, and scalable resources for accommodating a range of remote and communications payloads.

### RELATED APPLICATION

The present application claims the benefit of priority under 35 U.S.C. §119 from U.S. Provisional Patent Application Ser. No. 61/083,500, entitled “HYBRID SPACECRAFT FOR COMMUNICATIONS AND REMOTE SENSING,” filed on Jul. 24, 2008, which is hereby incorporated by reference in its entirety for all purposes.

### STATEMENT REGARDING FEDERALLY SPONSORED RESEARCH OR DEVELOPMENT

Not Applicable.

### FIELD OF THE INVENTION

The present invention relates generally to spacecraft, and more particularly to hybrid spacecraft for communications and remote sensing.

### BACKGROUND

Geosynchronous earth orbit (GEO) communications spacecraft do not include provisions for hosting remote sensing payloads, which require a low-jitter environment and precision attitude and orbit sensing. Standalone remote sensing spacecraft are highly customized for their specific remote sensing payloads and missions, take many years to develop (e.g., 5 years or more), and are designed according to government-program mission assurance requirements. The remote sensing spacecraft are not configurable to host different payload suites or to host high-power communications payloads. Furthermore, they are too expensive to be commercially viable.

Therefore, there is a need for hybrid spacecraft for communications and remote sensing.

### SUMMARY OF THE INVENTION

Various aspects of the disclosure provide hybrid spacecraft capable of hosting both a remote sensing payload and a communications payload. A hybrid spacecraft includes an isolation system for a remote sensing payload that isolates the remote sensing payload from spacecraft dynamics and disturbances, and prevents interaction between the remote sensing and communications payloads. The hybrid spacecraft may also include provisions for a communications payload including metering structure for large aperture antennas, and scalable resources for accommodating a range of remote and communications payloads.

In one aspect, a hybrid spacecraft, comprises a spacecraft bus, a communications payload mounted on the spacecraft bus, the communications payload configured to provide fixed satellite services (FSS) or broadcast satellite services (BSS), an isolation system mounted on the spacecraft bus, the isolation system including an isolation platform, and a remote sensing system mounted on the isolation platform of the isolation system, wherein the isolation system isolates the remote sensing system from vibrations on the spacecraft bus.

### BRIEF DESCRIPTION OF THE DRAWINGS

FIG. 1 shows a hybrid spacecraft according to an aspect of the present disclosure.

FIG. 2 shows an isolation system according to an aspect of the present disclosure.

FIG. 3 shows a close-up view of the isolation system in FIG. 2 according to an aspect of the present disclosure.

FIG. 4 shows a conceptual block diagram of a remote sensing system according to an aspect of the present disclosure.

FIG. 5 shows a conceptual block diagram of a “bent pipe” communications system according to an aspect of the present disclosure.

FIG. 6 shows a conceptual block diagram of a communications system according to another aspect of the present disclosure.

The accompanying drawings, which are included to provide further understanding of the invention and are incorporated in and constitute a part of this specification, illustrate aspects of the invention and together with the description serve to explain the principles of the invention.

### DETAILED DESCRIPTION OF THE INVENTION

In the following detailed description, numerous specific details are set forth to provide a full understanding of the subject technology. It will be obvious, however, to one ordinarily skilled in the art that the subject technology may be practiced without some of these specific details. In other instances, well-known structures and techniques have not been shown in detail to avoid obscuring concepts of the subject technology.

Reference will now be made in detail to aspects of the subject technology, examples of which are illustrated in the accompanying drawings, wherein like reference numerals refer to like elements throughout.

Various aspects of the disclosure provide hybrid spacecraft that can accommodate both a high-power commercial communications payload and a precision remote sensing payload. An advantage of a hybrid spacecraft for a remote sensing customer (e.g., government agency or commercial interest) is rapid access to space for remote sensing payloads and reduced cost of obtaining remote sensing data. An advantage for a communications service provider is a reduction in the spacecraft launch, bus, and insurance “overhead” costs, and a remote sensing mission operations revenue stream. The “subsidy” provided by hosting the remote sensing payload acts to reduce the per-transponder cost, increasing the communications service provider's return on investment. The viability of a hybrid business model depends on the availability of a spacecraft designed to cost-effectively accommodate a range of communications and remote sensing payloads. Various aspects of the disclosure provide configurable spacecraft that address these requirements.

In one aspect, a remote sensing payload is accommodated via a plug-in module, which dynamically isolates the remote payload from the effects of bus disturbances, including those due to reaction wheels (RWAs), solar array drives, and thrusters. The module includes a low-distortion composite structure with a high-bandwidth inertial measurements unit (IMU) and star trackers that provide a precision attitude reference, and a tunable isolator-strut interface to the spacecraft earth deck. The spacecraft includes a GPS-at-GEO autonomous orbit determination (OD) system that provides orbit position and time data necessary for remote sensing data reduction. The on-board system eliminates the need for the communications service proper or remote sensing customer to provide the expensive ground infrastructure needed to support a ranging-based precision OD system. The on-board system also allows the spacecraft to automatically control its own orbit, reducing mission operations cost. The spacecraft includes a plug-in data acquisition and transmission capability for telemetering the remote sensing mission data to the ground station. A metering structure and feed tower are provided for the communications antennas, which may be standard antennas used for C, Ku-band commercial communications missions, such as, for example, 2 to 3 meter antennas with F/D ratios of between 1.2 and 2. The spacecraft includes a configurable power system and equipment panels that can be expanded to accommodate the equipment needed to support, e.g., a 36-channel 5 kW communications payload.

Various aspects of the disclosure may include one or more of the following features:

1. A plug-in module for the remote sensing payload that provides dynamic isolation from spacecraft dynamics and disturbances, provides precision attitude sensing, and prevents interaction between the remote sensing payload and the communications payloads.

2. Provisions for a high-power geosynchronous earth orbit (GEO) communications payload, including metering structure for large aperture antennas needed to provide continental United States (CONUS), European, or Asian coverage.

3. A GPS-at-GEO autonomous orbit determination system that eliminates the need for the communications service provider to provide an expensive ground infrastructure for precision OD.

4. Spacecraft resource scalability that enables accommodation of a range of remote payloads and communications payloads.

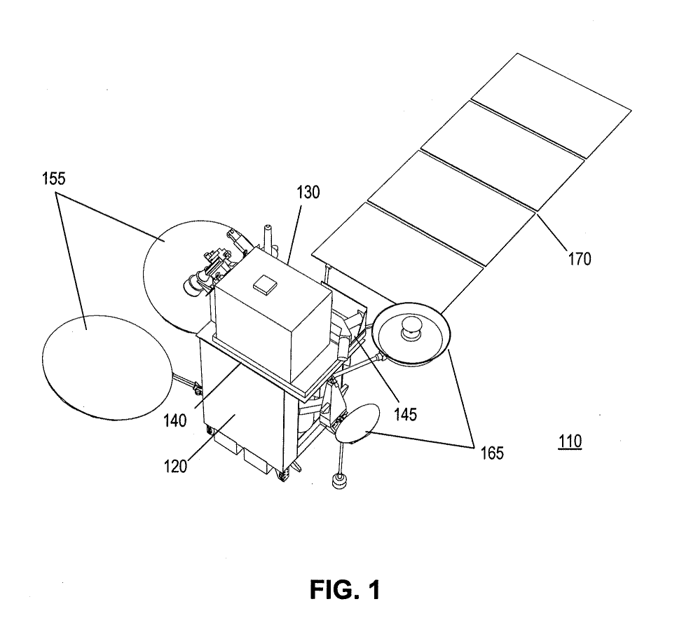

FIG. 1 shows a GEO hybrid spacecraft 110 according to an aspect of the disclosure. The hybrid spacecraft 110 comprises a communications payload 120, a remote sensing payload 130 and an isolation system 140 for dynamically isolating the remote sensing payload 130 from spacecraft dynamics and disturbances. The remote sensing payload 130 may include an imager (e.g., an advanced baseliner imager (ABI)), a sounder, a geostationary lighting mapper (GLM), and/or other remote sensing instruments. An imager may be used to image the surface of the Earth and/or the atmosphere for obtaining meteorological data. A sounder may be used to take radio metric measurements of the atmosphere to provide data on atmospheric properties. The communications payload 120 may include communications systems for fixed satellite services (FSS) and/or broadcast satellite services (BSS) as defined by the International Telecommunications Union (ITU).

The hybrid spacecraft 110 may also include star trackers and an inertial measurement unit (IMU) 145 for high accuracy attitude measurements. The hybrid spacecraft 110 may also include communications antennas 155 for the communications payload 120, antennas 165 for the remote sensing payload 130 and a solar panel 170. The antennas 165 may be used to transmit data from the remote sensing payload 130 to a ground station.

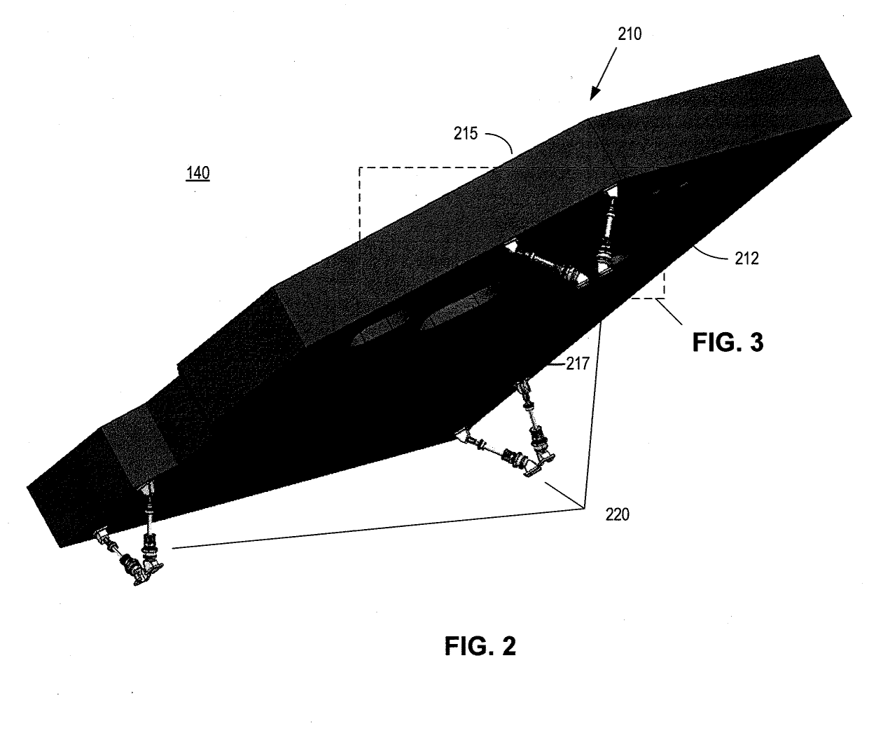

FIG. 2 shows perspective view of the isolation system 140 according to an aspect of the disclosure. The isolation system 140 comprises an isolation platform 210 and a plurality of isolator struts 220 (e.g., six isolator struts). Each isolator strut 220 is attached at one end to a bottom surface 212 of the isolation platform 210 and attached at the other end to the satellite bus. The satellite bus may comprise a framework on which the communications payload 140 and other components of the spacecraft 110 are mounted. Remote sensing instruments of the remote sensing payload 130 may be mounted on a top surface 215 of the isolation platform 210, an example of which is shown in FIG. 1.

The plurality of isolator struts 220 dynamically decouple the remote sensing payload mounted on the isolation platform 210 from spacecraft dynamics and disturbances. The isolator struts 220 do this by attenuating or dampening vibrations from the spacecraft bus. This prevents vibrations the rest of the spacecraft 110 from being transmitted through the spacecraft bus to the isolation platform 210. The attenuation of vibrations by the isolator struts 220 keeps the isolation platform 140 stable, thereby providing a stable platform for mounting precision remote sensing instruments that require a low-jitter environment. A range of different precision remote sensing instruments may be mounted on the isolation platform 210. Thus, the isolation platform 210 can accommodate a range of precision remote sensing instruments. Further, the isolation platform 210 may provide thermal isolation for the remote sensing payload 130 from the rest of the spacecraft 110.

The isolation system 140 can be readily attached to a spacecraft hosting a communication payload to provide a low-jitter stable platform to enable the spacecraft to also host precision remote sensing instruments. Thus, the isolation system 140 provides a plug-in module for a remote sensing payload 130 that dynamically isolates the remote sensing payload 130 the rest of the spacecraft, and prevents interactions between the remote sensing payload 130 and the communications payload 120. By isolating the remote sensing payload 130 from the rest of the spacecraft 110, the communications payload 120 and other components of the spacecraft 110 can be changed without affecting the remote sensing payload 120. Thus, the remote sensing payload 130 does not have to be redesigned to accommodate changes in the rest of the spacecraft 110.

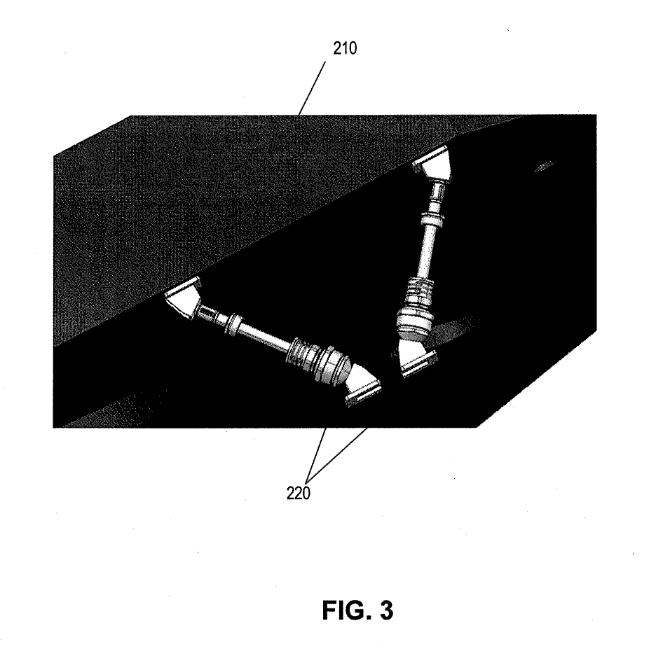

FIG. 3 shows a close-up view of a pair of the isolator struts 220 shown in FIG. 2. Additional details of the isolator struts can be found, for example, in application Ser. No. 12/187,299, entitled “SYSTEM FOR ISOLATING VIBRATION AMONG A PLURALITY OF INSTRUMENTS,” filed on Aug. 6, 2008, the specification of which is incorporated herein by reference. The attachment locations of the isolator struts 220 on the isolator platform 210 and the deck of the spacecraft 110 may be optimized to attenuate vibrations within a desired frequency band. Also, damping and/or stiffness properties of the isolator struts 220 may also be adjusted to optimize vibration attenuation. Techniques for optimizing the layout and properties of the isolator struts can be found in the above-referenced application.

The isolation platform 210 may also include holes 217 for running cables and wires to the remote sensing payload 130 on the isolation platform 210. The cables and wires may be looped into service loops to allow the cables and wires to move and provide slack between the isolation platform 210 and the deck of the spacecraft 110.

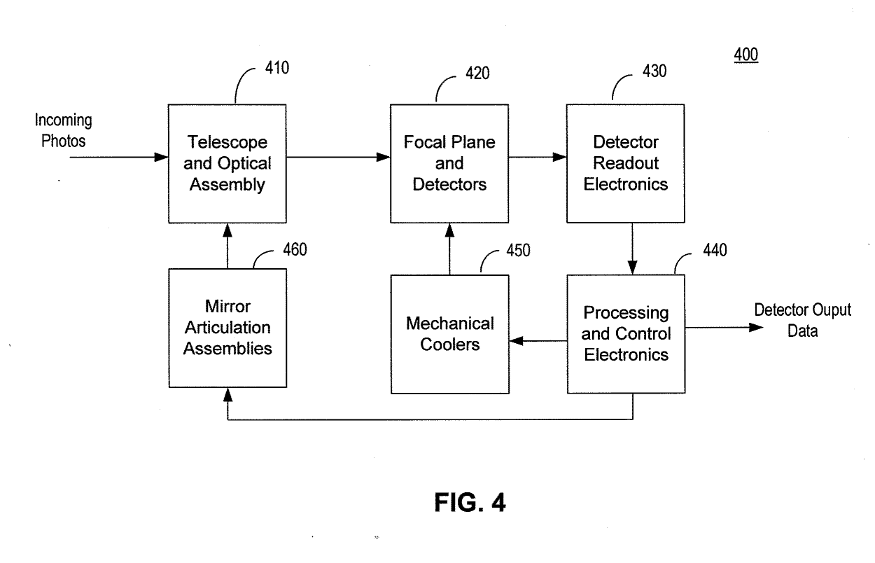

FIG. 4 shows a conceptual block diagram of a remote sensing system 400, which may be included as part of the remote sensing payload 130 accommodated on the hybrid spacecraft 110. The remote sensing system 400 includes a telescope and optical assembly 410, a focal plane including detectors 420, detector readout electronics 430, and processing and control electronics 440. The remote sensing system 400 also includes mechanical coolers 450 and mirror articulation assemblies 460.

In operation, incoming photons arriving at an aperture of the remote sensing system 400 are focused by the telescope and optical assembly 410 onto the focal plane with detectors 420. The detectors measure the incident radiation. The detectors may operate over a range of wavelengths in visible, infrared, or other bands. Optical elements within the telescope and optical assembly 410 may be articulated to allow different portions of a scene (e.g., Earth) to be observed. For example, scanning instruments may rotate mirrors to allow viewing of the entire earth disk, or a portion of it, over time. In this example, the mirror articulation assemblies 460 may include motors that rotate the mirrors to provide the scanning capability, which is commanded by the processing and control electronics 440.

To ensure adequate measurement signal-to-noise ratios, the focal planes and optics may be maintained at low temperature with cooling provided passively, or using the mechanical coolers 450. The mechanical coolers 450 may be commanded by the processing and control electronics 440. The measurements from the readout electronics 430, along with other information necessary to navigate the image (e.g., mirror angles), are provided to the processing and control electronics 440, which processes the measurements and other information for transmission to the ground.

To ensure that useful measurements are recorded, the spacecraft 110 should ensure that the motion of motion-sensitive instruments of the remote sensing system 400 is small over a measurement integration period. This capability is not generally provided by a standard communications spacecraft, but is provided by a hybrid spacecraft 110 according to the various aspects of the disclosure through the isolation platform 210.

In one aspect, motion-sensitive instruments of the remote sensing system 400 are mounted on the isolation platform 210, which provides a low-jitter stable platform. The motion-sensitive instruments may include the telescope and optical assembly 410 and the focal plane with detectors 420. Components of the remote sensing system 400 that are not sensitive to motion may be mounted to the spacecraft bus and coupled to the motion-sensitive instruments on the isolation platform 210 via cables and wires routed through the holes 217 in the isolation platform 210. Some or all of these components may also be mounted on the isolation platform 210.

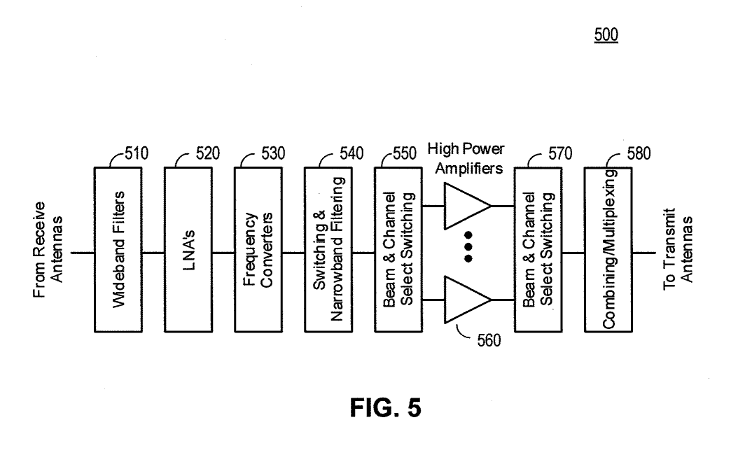

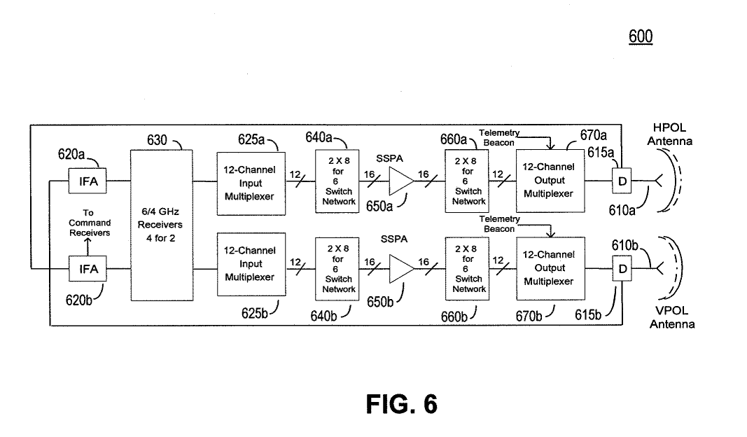

FIGS. 5 and 6 show block diagrams for “bent pipe” communication payloads, which may be included on the hybrid spacecraft 110. Such payloads may be used on GEO spacecraft for fixed satellite services (FSS) and/or broadcast satellite services (BSS) as defined by the International Telecommunications Union (ITU). FSS satellites operate with ground stations in known, fixed locations. Such spacecraft may be used for telephony, cable TV, or very small aperture terminal (VSAT) data networks. ITU frequency allocations for FSS service are included in the C-band (6/4 GHz), Ku-band (14/12 GHz), or Ka-band (30/20 GHz). BSS spacecraft support direct-to-home applications with dedicated orbit slots and frequencies assigned by the ITU, depending on where the spacecraft will operate (i.e., ITU regions 1, 2, or 3). BSS payloads typically operate in at Ku-band, with uplinks at 14 or 17 to 18 GHz, and downlinks from 11 to 12 GHz. These communications payloads may have from 20 to 40 channels of 24 to 27 MHz bandwidth.

FIG. 5 shows a conceptual block diagram of a communications system 500, which may be used for FSS or BSS and may be included as part of the communications payload 120. The communications system 500 receives uplink communication signals from Earth and retransmits the received signals as downlink communications signals to Earth. The communications system 500 comprises wideband filters 510, a plurality low noise amplifiers (LNAs) 520, frequency converters 530, switches and narrowband filters 540, a first plurality of beam and channel select switches 550, high power amplifiers 560, a second plurality of beam and channel select switches 570, and a combiner 580.

In operation, uplink communication signals are received via an antenna and wideband filtered by the wideband filters 510 to remove signals that are out of the band of operation. Next, the LNAs 520 amplify the received signal to raise their overall signal level and the frequency converters 530 translate the received frequencies (i.e., uplink frequencies) of the received signal into the transmission frequencies (i.e., downlink frequencies). Next, the narrowband filters and switches 540 are used to establish channelization and select input sources. The narrowband filters and switches 540 establishes channelization by splitting the received signals into a plurality of channels, which can be routed to different high power amplifiers and/or transmit antennas. Following this, the beams and channel select switches 550 and 570 on either side of the high power amplifiers 560 determine which of the amplifiers are used to amplify the signals on the different channels as well as select to which transmit beam a signal on a given channel is routed. Finally, high power channel filters are used to remove out-of-band signals and the combiner 580 re-combines signals on different channels for transmission to Earth via the transmit antennas.

FIG. 6 shows a conceptual block diagram of an FSS communication system 600, which may be included as part of the communications payload 120. The communications system 600 may handle 24 Ku-band channels with 12 channels transmitted on a horizontal polarization, and 12 channels transmitted on a vertical polarization. The dual polarizations allow signals to be transmitted within the same frequency bands on the different polarization, thereby providing frequency reuse. The communications system 600 includes a pair of antennas 610a and 610b (one for horizontal polarization and the other for vertical polarization). The communications system 600 also includes a pair of diplexers 615a and 615b, a pair of input filter assemblies (IFAs) 620a and 620b, a receiver bank 630, a pair of input multiplexers 625a and 625b, a pair of input switch networks 640a and 640b, two banks of solid state power amplifiers (SSPAs) 650a and 650b, a pair of output switch networks 660a and 660b, and a pair of output multiplexers 670a and 670b. Traveling wave tube amplifiers (TWTAs) may be used instead of or in addition to the SSPAs. Each bank of SSPAs 650a and 650b in the example shown in FIG. 6 includes 16 SSPAs.

In operation, the signals received by each antenna 610a and 610b are frequency partitioned by the respective diplexer 615a and 615b to route the received signals within an input frequency band (i.e., uplink frequency band) to the respective IFAs 620a and 620b. The received signals are then filtered by the respective IFAs 620a and 620b and then provided to the receiver bank 630. The receiver bank 630 may amplify, filter and/or frequency down convert the received signals. For example, the receiver bank 630 may down convert the received signals to lower frequencies for retransmission to Earth. The down-converted received signals are then inputted to the input multiplexers 625a and 625b, which split the received signals into a plurality of channels (e.g., 12 channels each). The input and output switch networks 640a, 640b, 660a and 660b route the signal on each channel to one of the SSPAs 650a and 650b. The output multiplexers 670a and 670b then combine the signals for transmission via the antennas 610a and 610b. The output multiplexers 670a and 670b may also multiplex satellite telemetry data with the signals for transmission.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A hybrid spacecraft, comprising:
a spacecraft bus;
a communications payload mounted on the spacecraft bus, the communications payload configured to provide fixed satellite services (FSS) or broadcast satellite services (BSS).;
an isolation system mounted on the spacecraft bus, the isolation system including an isolation platform; and
a remote sensing payload mounted on the isolation platform of the isolation system, wherein the isolation system isolates the remote sensing system from vibrations on the spacecraft bus.

2. The hybrid spacecraft of claim 1, wherein the isolation system comprises a plurality of isolator struts, wherein each isolator strut is attached at one end to the isolation platform and at the other end to the spacecraft bus.

3. The hybrid spacecraft of claim 1, wherein the remote sensing payload comprises an imager configured to image the Earth.

4. The hybrid spacecraft of claim 3, wherein the remote sensing payload comprises:
a plurality of detectors on a focal plane, each detector configured to measure incident radiation; and
an optical assembly for focusing incoming radiation onto the focal plane.

5. The hybrid spacecraft of claim 1, wherein the remote sensing payload comprises a sounder.

6. The hybrid spacecraft of claim 1, wherein the communications payload comprises a communications system configured to receive a communications signal from the Earth and to transmit the received communications signal back to Earth.

7. The hybrid spacecraft of claim 6, wherein the communications system comprises a frequency converter for converting frequencies of the received signals from an uplink frequency band to a downlink frequency band.

8. The hybrid spacecraft of claim 6, wherein the communications system comprises a plurality of power amplifiers configured to amplify the received signals.

9. The hybrid spacecraft of claim 8, wherein the communications system comprises:
an input multiplexer configured to split the received signals into a plurality of channels;
a switch network configured to route a signal on each of the plurality of channels to one of the plurality of power amplifiers; and
an output multiplexer configured to combine the amplified signals on the plurality of channels into a signal for transmission to Earth.

10. The hybrid spacecraft of claim 2, wherein the plurality of isolator struts are configured to dampen vibrations within a frequency band.

11. The hybrid spacecraft of claim 10, wherein the remote sensing payload is sensitive to vibrations at frequencies within the frequency band.

12. The hybrid spacecraft of claim 11, wherein the frequencies at which the remote sensing payload is sensitive depends on a measurement integration period of the remote sensing system.

13. The hybrid spacecraft of claim 4, wherein the optical assembly comprises:
one or more rotatable mirrors; and
a scanner for rotating the one or more mirrors to direct incoming radiation from different directions onto the focal plane.

14. The hybrid spacecraft of claim 1, wherein the remote sensing payload comprises a geostationary lighting mapper.

15. The hybrid spacecraft of claim 6, wherein the communications signal is within a frequency band selected from a group consisting of a C-band, Ku-band and Ka band.

16. The hybrid spacecraft of claim 6, wherein the communications signal comprises a television broadcast signal.

17. The hybrid spacecraft of claim 6, wherein the communications system is configured to multiplex spacecraft telemetry data onto the communications signal transmitted back to Earth.
